(19) United States
(12) Patent Application Publication
(10) Pub. No.: US 2007/0124344 A1
(43) Pub. Date: May 31, 2007

(54) Method, apparatus and program storage device for providing web services-based data replication for Heterogeneous storage systems

(75) Inventors: Maria Savarimuthu Rajakannimariyan, San Jose, CA (US); Rainer Wolafka, Bad Soden (DE)

Correspondence Address: DAVID W. LYNCH;CHAMBLISS, BAHNER & STOPHEL, 1000 TALLAN SQUARE-S, TWO UNION SQUARE, CHATTANOOGA, TN, 37402, US

(73) Assignee: INTERNATIONAL BUSINESS MACHINES CORPORATION

(21) Appl. No.: 11/289,027

(22) Filed: Nov. 29, 2005

(51) Int. Cl. G06F 17/30

(52) U.S. Cl. 707/204

(57) ABSTRACT

A method, apparatus and program storage device for providing web services-based data replication for heterogeneous storage systems. A web services interface is provided in a storage subsystem to provide access of replication functions of the storage subsystem by a remote requesting agent. The web services interface may also authenticate a remote requesting agent and data encryption to ensure privacy. The web services interface may also break the volume being replicated into junks of a predetermined size for later merging to form the volume at the remote requesting agent.

### BACKGROUND OF THE INVENTION

1. Field of the Invention

This invention relates in general to a storage subsystems, and more particularly to a method, apparatus and program storage device for providing web services-based data replication for heterogeneous storage systems.

2. Description of Related Art

A Web service is a software system designed to support interoperable machine-to-machine interaction over a network. A Web service uses an interface that is described in a machine-processable format such as the Web Services Description Language (WSDL). WSDL is an XML vocabulary that provides a standard way of describing service Interface Definition Languages (IDLs). WSDL is the resulting artifact of a convergence of activity between the Network Accessible Service Specification Language (NASSL) developed by IBM and the Specification and Description Language (SDL) developed by Microsoft. WSDL provides a simple way for service providers to describe the format of requests and response messages for remote method invocations (RMIs). WSDL addresses this topic of service IDLs independently of the underlying protocol and encoding requirements. In general, WSDL provides an abstract language for defining the published operations of a service with their respective parameters and data types. The language also addresses the definition of the location and binding details of the service.

Systems other than the system providing the web service may interact with the web service in a manner prescribed by its interface using messages, which may be enclosed in a SOAP envelope, or follow a REST approach. These messages are typically conveyed using HTTP, and are normally comprised of XML in conjunction with other Web-related standards. Software applications written in various programming languages and running on various platforms can use web services to exchange data over computer networks like the Internet in a manner similar to inter-process communication on a single computer.

Currently data replication of storage subsystems is limited to a specific distance between the devices and requires a specific interface and protocol (such as dedicated fibre channel adapters and connectivity). As a result data replication between storage subsystems is restricted to certain geographical boundaries. Furthermore, replication of data is currently only possible between storage subsystems of a particular type and vendor (homogeneous). Another limitation of the current data replication technology is the fact that partners of the replication, source and target(s), need to know of each other and cannot create a replication relationship dynamically. Thus, the limitations of the current data replication of storage subsystem technology are the limited distance for data replication, special technology and connectivity are required, storage subsystem of the same type and vendor are required and no dynamic discovery of replication target(s) is possible.

It can be seen that there is a need for a method, apparatus and program storage device for providing web services-based data replication for heterogeneous storage systems.

### SUMMARY OF THE INVENTION

To overcome the limitations in the prior art described above, and to overcome other limitations that will become apparent upon reading and understanding the present specification, the present invention discloses a method, apparatus and program storage device for providing web services-based data replication for heterogeneous storage systems.

The present invention solves the above-described problems by providing a web services interface is provided in a storage subsystem to provide access of replication functions of the storage subsystem by a remote requesting agent. The web services interface may also authenticate a remote requesting agent and data encryption to ensure privacy. The web services interface may also break the volume being replicated into junks of a predetermined size for later merging to form the volume at the remote requesting agent.

A storage system in accordance with an embodiment of the present invention includes at least one target storage subsystem having a web services interface for providing Internet access to a set of functions of the at least one target storage subsystem and a requesting storage subsystem having a web services interface, the web services interface of the requesting storage subsystem being configured to identify a web services interface of the at least one target storage subsystem and initiate a function of the at least one target storage subsystem via the web services interfaces of the requesting storage subsystem and the at least one target storage subsystem.

In another embodiment of the present invention, a storage subsystem is provided. The storage subsystem includes at least one storage device and a web services interface, the web services interface being configured to perform web initiable storage functions of the at least one storage device.

In another embodiment of the present invention, a method for performing a remote storage activity is provided. The method includes identifying a storage subsystem having a web services interface for providing access to a web initiable storage function, coupling to the identified storage system via a network using a network protocol and initiating execution of the web initiable storage function.

In another embodiment of the present invention, a program storage device is provided. The program storage device includes program instructions executable by a processing device to perform operations for performing a remote storage activity, wherein the operations include identifying a storage subsystem having a web services interface for providing access to a web initiable storage function, coupling to the identified storage system via a network using a network protocol and initiating execution of the web initiable storage function.

In another embodiment of the present invention, another storage subsystem is provided. This storage subsystem includes means for storing data and means, operatively coupled to the means for storing, for enabling web initiable services associated with the means for storing data to be performed.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a computer network according to an embodiment of the present invention;

FIG. 2 illustrates a block diagram of a storage subsystem according to an embodiment of the present invention;

FIG. 3 illustrates a web services architecture according to an embodiment of the present invention;

FIG. 4 illustrates a storage subsystem according to an embodiment of the present invention;

FIG. 5 illustrates a web service interface according to an embodiment of the present invention;

FIG. 6 illustrates the process for enabling a requester storage subsystems to access target storage subsystems and to initiate functions at the target storage system via web services according to an embodiment of the present invention; and

FIG. 7 is a flow chart of the method for providing web services-based data replication for heterogeneous storage systems according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing web services-based data replication for heterogeneous storage systems. A web services interface is provided in a storage subsystem to provide access of replication functions of the storage subsystem by a remote requesting agent. The web services interface may also authenticate a remote requesting agent and data encryption to ensure privacy. The web services interface may also break the volume being replicated into junks of a predetermined size for later merging to form the volume at the remote requesting agent.

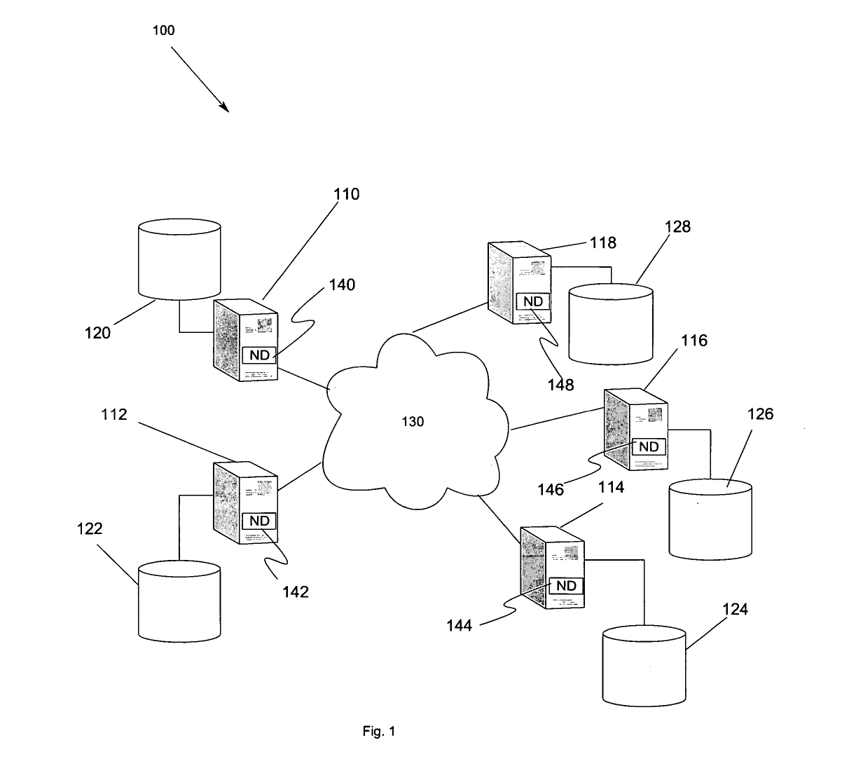

FIG. 1 illustrates a computer network 100 according to an embodiment of the present invention. Computer network 100 includes a plurality of storage subsystems 110-118. The storage subsystems 110-118 include physical storage devices 120-128. The storage subsystems 110-118 are coupled via a network 130. For example, the network 130 may be the Internet and each of the storage systems then would include a network device 140-148 for accessing the network 130, i.e., the Internet. However, network 130 may also include a simplified network connection such as a local area network (LAN) or a larger network such as a wide area network (WAN). Furthermore, network 130 depicted in FIG. 1 is intended as a representation of a possible operating network containing the present invention and is not meant as an architectural limitation.

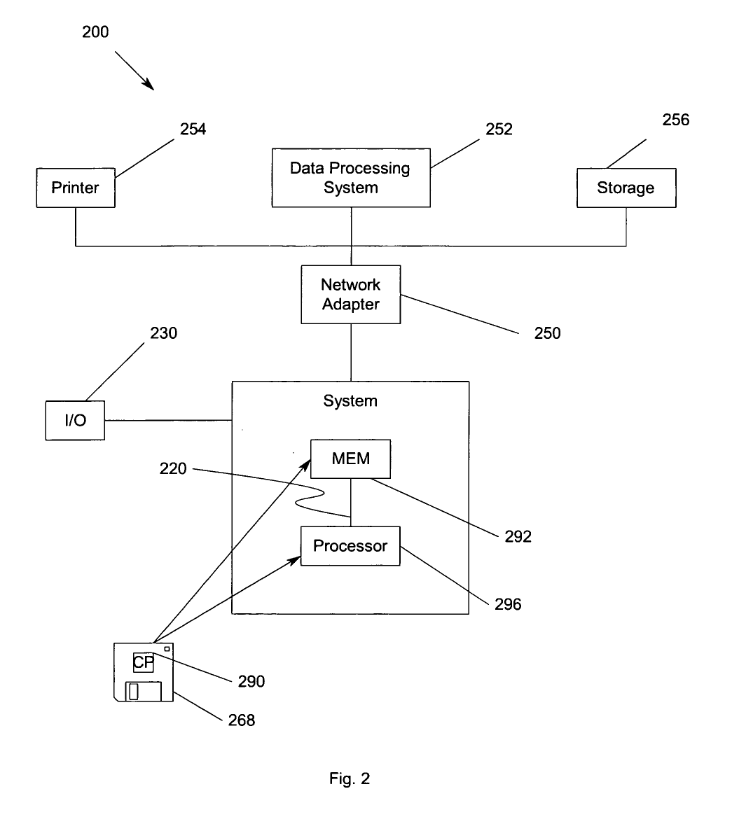

FIG. 2 illustrates a block diagram of a storage subsystem 200 according to an embodiment of the present invention. The storage subsystem 200 includes at least one processor 296 coupled directly or indirectly to memory elements 292 through a system bus 220. The memory elements 292 can include local memory, bulk storage, and cache memories, which provide temporary storage of at least some program, code in order to reduce the number of times code must be retrieved from bulk storage during execution.

Input/output or I/O devices 240 (including but not limited to keyboards, displays, pointing devices, etc.) can be coupled to the system either directly to the system or through intervening I/O controllers.

Network adapters 250 may also be coupled to the storage subsystem 200 to enable the storage subsystem 200 to become coupled to, for example, other data processing systems 252, remote printers 254 or storage devices 256 through intervening private or public networks 260. Modems, cable modem and Ethernet cards are just a few of the currently available types of network adapters. Thus, the storage subsystem is suitable for storing and/or executing program code according to an embodiment of the present invention.

Embodiments of the present invention may take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, embodiments of the present invention may take the form of a computer program product 290 accessible from a computer-usable or computer-readable medium 268 providing program code for use by or in connection with a computer or any instruction execution system.

For the purposes of this description, a computer-usable or computer readable medium 268 can be any apparatus that can contain, store, communicate, propagate, or transport the program for use by or in connection with the instruction execution system, apparatus, or device. The medium 268 may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Accordingly, the computer program 290 comprise instructions which, when read and executed by the system 200 of FIG. 2, causes the system 200 to perform the steps necessary to execute the steps or elements of the present invention as will be described herein.

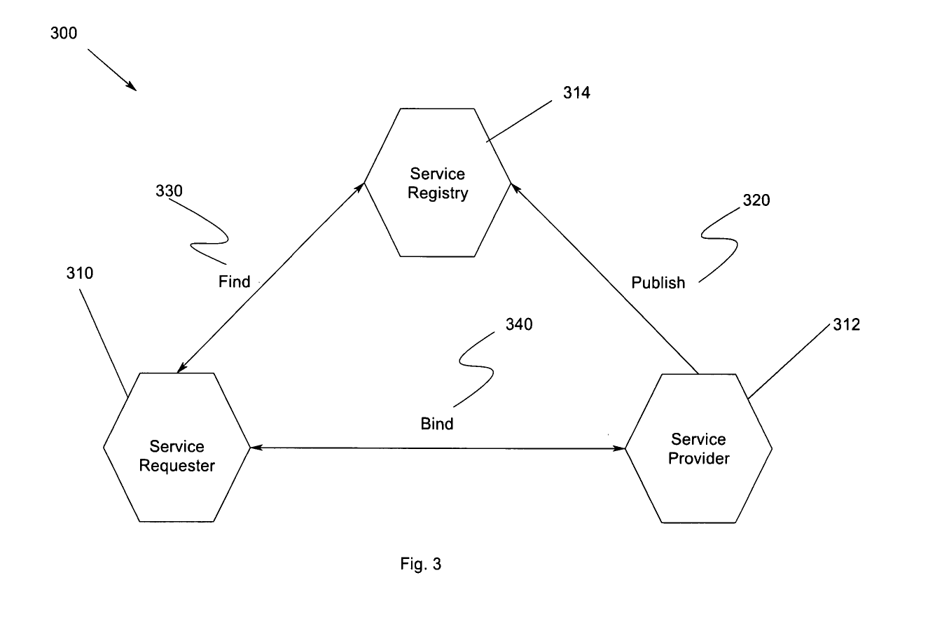

FIG. 3 illustrates a web services architecture 300 according to an embodiment of the present invention. The web services architecture 300 supports web services in terms of three roles. The three roles provided in one embodiment of a web service architecture includes at least a service provider, a service requester and a service registry. A service is an implementation of a service description and a service description is the metadata describing the service. This metadata must include sufficient information for a service requestor to access the service it describes including its interface and location; resource discovery metadata such as classification may also be included.

A service provider publishes a service description to a service registry. A service requester then finds the service description via the service registry. The services description contains sufficient information for the service requestor to bind to the service provider to use the service. If the service requester has access to the service description via some other means, e.g., such as hard-coding, the service requester can go direct to the service provider.

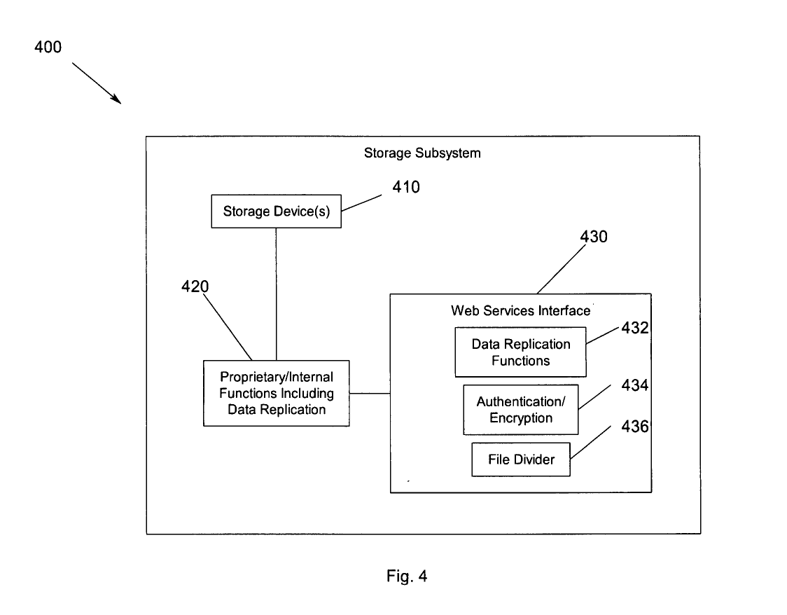

FIG. 4 illustrates a storage subsystem 400 according to an embodiment of the present invention. In FIG. 4, the storage subsystem 400 includes at least one storage device 410. Proprietary or internal functions 420 are provided by the at least one storage device 410. The proprietary or internal functions 420 include functions for performing data replication. The storage subsystem 400 also includes a web services interface 430 that defines published operations of a service with respective parameters and data types so that applications that were written for different vendors' platforms, potentially in different programming languages and on different operating systems may communicate and initiate defined web services. For example, a web services interface 430 includes web initiable functions for performing data replication 432. The web services interface 430 may also include web initiable functions for performing authentication/encryptions 434 and file division 436. Since volumes to be replicated might be very large, the volume may need to be broken down in smaller junks to make the data transfer with Web Services feasible. If this is the case, the web services interface 430 may also include web initiable functions for file division 436. The file portions or junks created by the file divider 436 are transferred over TCP/IP using the web services feature. A target subsystem will take these junks, extract the data from the incoming signal and reassemble the entire target volume. Thus, the web services interface 430 allows a storage subsystems of one vendor to initiate storage functions of a storage subsystem of a different vendor, i.e., the web services interface 430 enables interoperability between vendor systems.

One example of pseudo-code is shown herein below that describes how the data transfer is performed conceptually.

for (all_volumes_to be_replicated) {

divide_volume_into_junks( );
while (more_data_to_replicate) {

send_data_junk_to_target (XML via SOAP attachment);

}

}

The target subsystem needs to take these junks, extract the data from the XML file from the SOAP message and assemble the entire target volume. One example of pseudo-code for implementing the send data junk_to_target on the target side conceptually looks like:

send_data_junk_to_target {

| | |
|---|---|
| write_to_disk ( ); | // reconstruct_entire_volume |

}

The storage subsystem 400 exposes a web services interface 430 to the public that allows authenticated users to invoke internal functionality 432 using standard protocols over the Internet. For example, the Web Services interface 430 may provide a uniform set of functions 432 needed for the data replication using the standard Web Services Definition Language (WSDL) interface. The proprietary technology 420 of the different storage systems and vendors is hidden underneath the standard web services interface 430 and is irrelevant for the actual data replication. Using this approach data can be replicated across storage subsystems from different vendors directly on subsystem level without any host system involvement.

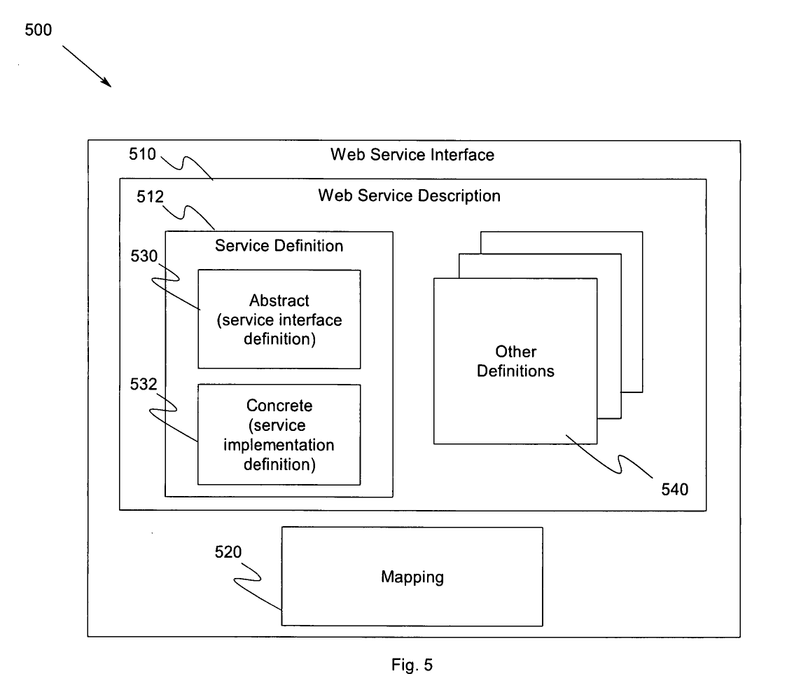

FIG. 5 illustrates a web service interface 500 according to an embodiment of the present invention. The web service interface 500 includes a web service description 510 and internal mapping 520. The mechanics of message exchange are provided by the web service description (WSD) 510. The WSD 510 is a machine-processable specification of the Web service's interface that defines the message formats, datatypes, transport protocols, and transport serialization formats that should be used between a requester agent and a provider agent. The WDS 510 may also specify one or more network locations (“endpoints”) at which a provider agent can be invoked, and may provide some information about the message exchange pattern that is expected.

The web service interface 500 is an interface that describes a collection of operations that are network accessible through standardized XML messaging. A Web service is described using a standard, formal XML notion, called its service definition 512. The service definition 512 provides the details necessary to interact with the service, including message formats (that detail the operations), transport protocols and location. Additional definitions 540 may also be provided to provide additional tasks. The web service interface 500 thus hides the implementation details of the service, allowing it to be used independently of the hardware or software platform on which it is implemented and also independently of the programming language in which it is written. This allows and encourages web services-based applications to be loosely coupled, component-oriented, cross-technology implementations. The web service interface 500 fulfills a specific task or a set of tasks, and can be used alone or with other web services to carry out a complex aggregation or a business transaction.

The service definition 512 includes the abstract (service interface definition) 530 and the concrete (service implementation definition) 532. The description of a Web service interface, independent of implementation details, is referred to as the abstract 530. Within a WSDL document, this abstract interface definition 430 is primarily made up of the interface and message constructs. It is further supported by the types construct, which is often classified separately. Specific location and implementation information about a Web service are provided by the concrete part (service implementation definition) 532. The concrete part (service implementation definition) 532 defines network location, protocols, security requirements and other attributes specific to a particular instance of a service endpoint for a binding.

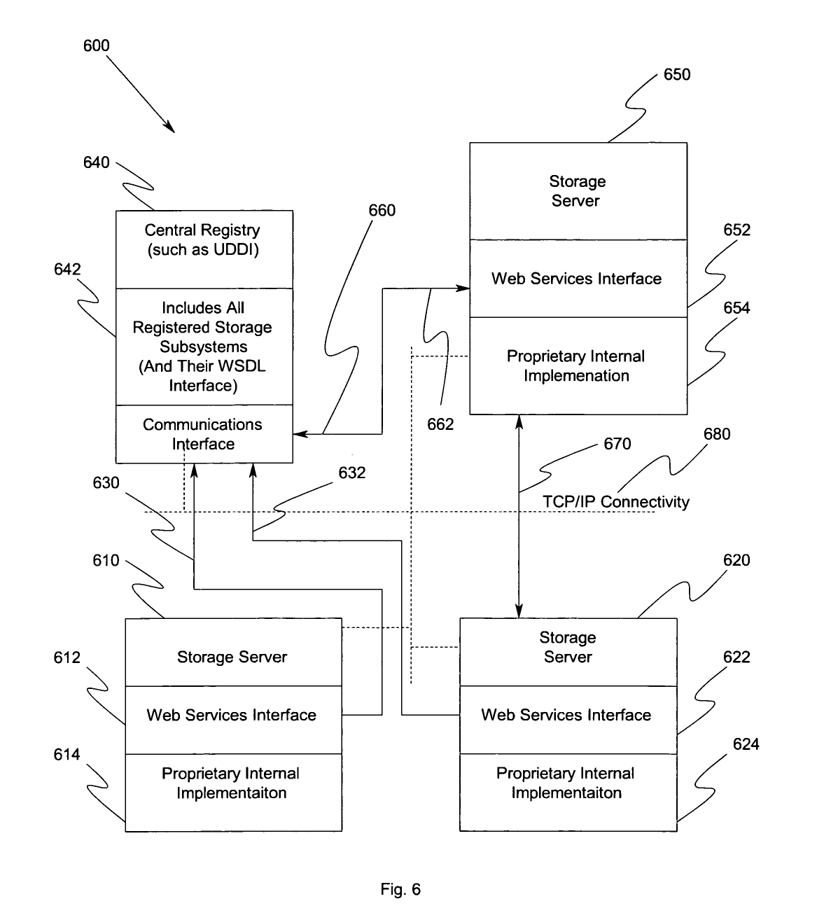

FIG. 6 illustrates the process 600 for enabling a requester storage subsystem to access target storage subsystems and to initiate functions at the target storage system via web services according to an embodiment of the present invention. FIG. 6 shows storage subsystems 610, 620, 650 and central registry 640 being coupled via TCP/IP connectivity 680. In FIG. 6, storage subsystems 610, 620 each register via signals 630, 632 with a central registry 640 having a communication interface 644, e.g., a Universal Description, Discovery, and Integration (UDDI) registry. UDDI is a platform-independent, XML-based registry for businesses worldwide to list on the Internet. The storage subsystems 610, 620 provide their capability by publishing their WSDL interface (WebServices Description Language), which includes the properties of the storage subsystem, e.g., name, type, supported copy services features and more. The central registry 640 provides a database 642 that includes all registered storage subsystems (and their WSDL interfaces). The WSDL interface 612, 622, 652 enable communication between storage subsystems of different vendors.

After the storage subsystems 610, 620 have registered with the registry, the storage subsystems 610, 620 can be discovered dynamically by other storage subsystems by means of the directory service. Another storage subsystem, storage server 650, can (on-demand) send a query 660 to the registry to identify possible target storage subsystems. This query can be limited to certain features (filtered), such as all servers that provide a certain copy service feature, all storage subsystems at a location, all storage subsystems of a defined type, or other filter parameter provided as information in the query. In this manner, partners of a data replication can be discovered dynamically and thus provides new “on-demand” or provisioning applications. If required, storage subsystems 610, 620 may also delete its entry from the registry 640. Based on the result 662 coming back from the registry 640 to the requesting storage subsystem 650, a partner (or more) for the data replication (target) is chosen, i.e., storage server 620 in FIG. 6. Then, the source 650 and target 620 storage subsystems talk directly to each other via connection 670. The source 650 and target 620 storage subsystems use their web services interface 622, 652 to transmit data (replicated) over the Internet.

As shown in FIG. 6, each of the storage subsystems 610, 620, 650 includes a web service interface 612, 622, 652. The storage subsystems 610, 620, 650 also include proprietary or internal functions 614, 624, 654 as was shown in FIG. 4. The web service interfaces 612, 622, 652 may also provide the web services technology stack that takes care of authentication and if needed also provides data encryption. Thus, only legitimate users can access the exposed web services interfaces 612, 622, 652 and data confidentiality is taken care of.

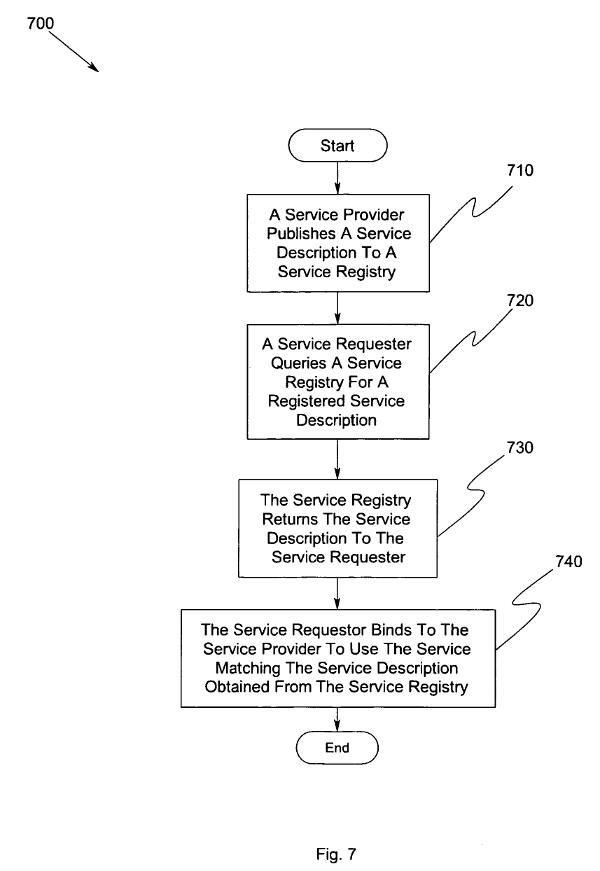

FIG. 7 is a flow chart 700 of the method for providing web services-based data replication for heterogeneous storage systems according to an embodiment of the present invention. In FIG. 7, a service provider publishes a service description to a service registry 710. A service requester queries a service registry for a registered service description 720. The service registry returns the service description to the service requester 730. The services description contains sufficient information for the service requestor to bind to the service provider to use the service. Thus, the service requestor binds to the service provider to use the service matching the service description obtained from the service registry 740. If the service requester has access to the service description via some other means, e.g., such as hard-coding, the service requester can go direct to the service provider.

Accordingly, the web service interface that is provided in a storage subsystem according to an embodiment of the present invention provides new and unique web-based approach for storage system data replication, wherein there are no distance limits between partners of the data replication and no specific technology or connectivity needed. Dynamic discovery of nodes participating in data replication (new “on-demand” and provisioning capabilities) is enabled by providing a web service interface in a storage subsystem 400 according to an embodiment of the present invention. Thus, data replication may be performed across storage subsystems and vendors using a more flexible programmatic approach for data replication.

The foregoing description of the embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A storage subsystem, comprising:
at least one storage device; and
a web services interface, the web services interface being configured to perform web initiable storage functions of the at least one storage device.

2. The storage subsystem of claim 1, wherein the web services interface is further configured to publish a description of services associated with the at least one storage device that may be accessed via the web services interface.

3. The storage subsystem of claim 2, wherein the web services interface publishes the description of services to a central registry.

4. The storage subsystem of claim 1, wherein the web services interface is configured to authenticate a requesting storage subsystem.

5. The storage subsystem of claim 1, wherein the web services interface is configured to encrypt data provided to a requesting storage subsystem.

6. The storage subsystem of claim 1, wherein the functions comprises replication of data of the at least one storage device to a requesting storage subsystem.

7. The storage subsystem of claim 6, wherein the web services interface is configured to break the volume being replicated into junks of a predetermined size for later merging to form the volume at the requesting storage subsystem.

8. The storage subsystem of claim 1 further comprising proprietary functions inaccessible via the web services interface.

9. The storage subsystem of claim 1, wherein the web services interface is configured to initiate storage functions at a remote storage subsystem.

10. The storage subsystem of claim 1, wherein the web services interface further comprises means for enabling web initiable services associated with the at least one storage device to be performed in response to communication with a remote storage subsystem.

11. A method for performing a remote storage activity, comprising:
identifying a storage subsystem having a web services interface for providing access to a web initiable storage function;
coupling to the identified storage system via a network using a network protocol; and
initiating execution of the web initiable storage function.

12. The method of claim 11, wherein the identifying a storage subsystem further comprises:
sending a query to a central registry requesting information regarding storage subsystems having a web services interface for providing access to storage functions; and
receiving a response identifying a storage subsystem having a web services interface for providing access to storage functions.

13. The method of claim 11 further comprising publishing by a storage subsystem at a registry a web services interface identifying web initiable storage functions.

14. The method of claim 13 further comprising recording web service interfaces published by storage subsystems.

15. The method of claim 14, wherein the identifying a storage subsystem further comprises:
receiving a query at the registry requesting information regarding storage subsystems having a web services interface for providing access to storage functions; and
sending a response identifying a storage subsystem having a web services interface for providing access to storage functions based upon the recorded web services interfaces published by storage subsystems.

16. The method of claim 11, wherein the coupling to the identified storage system via a network using a network protocol further comprises coupling to the identified storage subsystem using TCP/IP connectivity.

17. The method of claim 11, wherein the initiating execution of the web initiable storage function further comprises authenticating a requesting storage subsystem.

18. The method of claim 17, wherein the initiating execution of the web initiable storage function further comprises encrypting data provided to the requesting storage subsystem.

19. The method of claim 17, wherein the initiating execution of the web initiable storage function further comprises breaking a volume into junks of a predetermined size for later merging to form the volume at a requesting storage subsystem.

20. A program storage device, comprising:
program instructions executable by a processing device to perform operations for performing a remote storage activity, the operations comprising:
identifying a storage subsystem having a web services interface for providing access to a web initiable storage function; and
coupling to the identified storage system via a network using a network protocol;
initiating execution of the web initiable storage function.

21. The program storage device of claim 20, wherein the identifying a storage subsystem further comprises:
sending a query to a central registry requesting information regarding storage subsystems having a web services interface for providing access to storage functions; and
receiving a response identifying a storage subsystem having a web services interface for providing access to storage functions.

22. The program storage device of claim 20 further comprising publishing by a storage subsystem at a registry a web services interface identifying web initiable storage functions.

23. The program storage device of claim 22 further comprising recording web service interfaces published by storage subsystems.

24. The program storage device of claim 20 further comprising recording web service interfaces published by storage subsystems.

25. The program storage device of claim 24, wherein the identifying a storage subsystem further comprises:
receiving a query at the registry requesting information regarding storage subsystems having a web services interface for providing access to storage functions; and
sending a response identifying a storage subsystem having a web services interface for providing access to storage functions based upon the recorded web services interfaces published by storage subsystems.

26. The program storage device of claim 20, wherein the initiating execution of the web initiable storage function further comprises authenticating a requesting storage subsystem and encrypting data provided to the requesting storage subsystem.

27. The program storage device of claim 20, wherein the initiating execution of the web initiable storage function further comprises breaking a volume into junks of a predetermined size for later merging to form the volume at a requesting storage subsystem.
